(19) United States
(12) Patent Application Publication
(10) Pub. No.: US 2022/0024320 A1
(43) Pub. Date: Jan. 27, 2022

(54) BRAKE MODULE FOR A MAGNETICALLY SUSPENDABLE VEHICLE

(71) Applicant: HARDT IP B.V., Delft (NL)

(72) Inventors: Luc Johan Ries DE GOEIJ, 's-Gravenhage (NL); Marinus Wilhelmus Eliza VAN DER MEIJS, 's-Gravenhage (NL); Bauke Jan KOOGER, Rotterdam (NL)

(21) Appl. No.: 17/311,439

(22) PCT Filed: Dec. 11, 2019
(86) PCT No.: PCT/NL2019/050825

§ 371 Date: Jun. 7, 2021

(51) Int. Cl. B60L 7/28; B60L 13/08; B60L 13/00; E01B 25/32; E01B 25/30

(52) U.S. Cl. CPC B60L 7/28; B60L 13/08; B60L 2200/26; E01B 25/32; E01B 25/305; B60L 13/006

(57) ABSTRACT

Therefore, a first aspect provides a brake module for a magnetically suspended vehicle. The brake module comprising a first magnetically active brake element coupled to a first brake magnet actuator comprised by the brake module. The first brake magnet actuator is arranged to control the first magnetically active element to provide a first magnetic brake field of a pre-determined magnitude at a first pre-determined location relative to the brake module, of which first magnetic brake field the first field lines are, in use, substantially horizontal and substantially perpendicular to a direction of travel of the vehicle. By providing an Eddy current brake having magnetic field components that are substantially horizontally oriented, influence of magnetic forces excited by the Eddy currents generated on the (vertical) suspension are reduced and preferably minimised.

### TECHNICAL FIELD

The various aspects and examples thereof relate to the field of providing brakes for magnetically suspendable vehicles and Eddy current brakes in particular.

### BACKGROUND

Eddy currents are known for their braking effect without physical contact between two units between which the braking force is generated. Examples are rollercoasters and high-speed trains. In the latter, like the 700 Series Shinkansen, circular Eddy currents brakes are provided comprising a disk around an axle of a bogie and a stationary magnet. In the German ICE 3, linear Eddy current brakes are provided.

### SUMMARY

Using Eddy current brakes and linear Eddy current brakes in particular result in forces on the vehicle perpendicular to the direction of movement of the vehicle. In Rollercoasters and high-speed trains like the German ICE 3, magnets provide a magnetic field oriented vertically, which magnets may be moves towards rails in the track. In the ICE 3, the train carries magnets that interact with the rails on which the train rides. Besides a braking force, parallel to the direction of movement, this also results in forces parallel to the magnetic field orientation. These forces result in repulsion and, if the conductor is ferromagnetic, also in attraction between the conductor of the brake and magnet of the brake.

Rollercoasters and high speed trains like the German ICE 3 move using wheels that are in physical contact with rails below the vehicles. In this way, the train is constrained between two rails. Hence, use of linear Eddy current brakes with horizontally oriented field, has no major effect on stability of the vehicle during braking. If a vertically oriented field is used, any additional forces are compensated by the weight of the train.

However, if a vehicle is magnetically (contactless) suspended, magnetic forces generated by operation an Eddy current brake by means of a vertically oriented field may have consequences for the stability of the vehicle due to lack of the restraint of rails. In particular on stability in the vertical direction may be an issue and such stability may in worst case result in loss of suspension at all.

Therefore, a first aspect provides a brake module for a magnetically suspended vehicle. The brake module comprising a first magnetically active brake element coupled to a first brake magnet actuator comprised by the brake module. The first brake magnet actuator is arranged to control the first magnetically active element to provide a first magnetic brake field of a pre-determined magnitude at a first pre-determined location relative to the brake module, of which first magnetic brake field the first field lines are, in use, substantially horizontal and substantially perpendicular to a direction of travel of the vehicle.

By providing an Eddy current brake having magnetic field components that are substantially horizontally oriented, influence of magnetic forces excited by the Eddy currents generated on the (vertical) suspension are reduced and preferably minimised.

An implementation provides a brake module further comprising a second magnetically active brake element coupled to a second brake magnet actuator, the second brake magnet actuator being arranged to control the second magnetically active element to provide a second magnetic brake field of a pre-determined magnitude at a second pre-determined location relative to the brake module, of which second magnetic brake field the second field lines are, in use, substantially parallel to the field lines of the first magnetic brake field and have an orientation opposite therefrom, wherein a first pole from which the first field lines debouch is facing away from the second magnetically active element and a second pole from which the second field lines debouch is facing away from the first magnetically active element.

In this implementation, lateral forces due to magnetic field induced by Eddy currents on either side of a bogie of the vehicle may eliminate one another if they have the same magnitude. A bogie, in this respect, is an arrangement for providing suspension of a vehicle relative to a track. As such, the bogie may comprise hinges, springs, other elements or a combination thereof for providing safe and/or comfortable suspension.

Another implementation of the brake module comprises a magnetically active guide element arranged to provide a magnetic guide field of which magnetic guide field lines, in use, are substantially horizontal and substantially perpendicular to a direction of travel of the vehicle. This implementation further comprises a guide magnet actuator arranged to control the magnetically active guide element to provide a magnetic guide field of a pre-determined magnitude at a first pre-determined location relative to the brake module; and a controller. The controller is arranged to obtain a total required force to obtain or maintain a particular position of the vehicle relative to a transportation infrastructure, based on a required braking force to be provided by actuation of the magnetically active brake elements, determine a magnitude of the magnetic brake field and a resulting lateral brake force lateral to the brake module and control the guide actuator enabling the magnetically active guide element to provide a magnetic guide field at the pre-determined location resulting in a magnetic guide force such that the sum of the lateral brake force and the magnetic guide force is substantially equal to the total required force.

In particular in a bend and/or when a brake rail is provided at only one side of the vehicle, lateral forces due to braking, for example induced by Eddy currents, do not eliminate one another. In such case, additional control is required, which is provided in this implementation.

A second aspect provides a vehicle arranged to be magnetically suspendable relative to at least one guide rail comprised by a transportation infrastructure, the vehicle comprising a brake module according to the first aspect.

A third aspect provides a transportation infrastructure arranged for transportation of a vehicle according to the second aspect, the transportation infrastructure providing a track arranged to provide guidance to the vehicle, the infrastructure comprising a braking rail provided along the track, the braking rail being arranged to engage with the brake module comprised by the vehicle and provided along the track such that it is provided at the pre-determined first location relative to the brake module.

In an implementation of the third aspect, wherein the braking rail comprises a layered structure. In this implementation, currents excited in the rail may be controlled and reduced or suppressed in particular.

In another implementation, at least two layers comprise materials having different magnetic and/or electrical and/or conductive properties.

Different materials provide different Eddy current brake characteristics at different velocities of the vehicle. Providing brake rail with different materials in different layers provides efficient braking at a wide velocity range. Furthermore, incorporating a layer comprising a ferromagnetic material may provide use of the braking rail for other purposes, including, but not limited to guiding, propulsion and suspension.

It is noted that whereas the implementations discussed below relate to vehicles that are suspended from above, implementations of this various aspects on concepts with floating vehicles magnetically suspended from below are not excluded.

### BRIEF DESCRIPTION OF THE DRAWINGS

The various aspects and implementations thereof will now be discussed in further detail in conjunction with drawings. In the drawings,

FIG. 1: shows a cross-section of a transportation infrastructure comprising a tube and a vehicle provided therein;

FIG. 2: shows an Eddy current brake;

FIG. 3: shows a more detailed view of FIG. 1;

FIG. 4 A: shows a first actuable magnetic element;

FIG. 4 B: shows a second actuable magnetic element;

FIG. 5: shows a top view of a switch in the transportation infrastructure;

FIG. 6 A: shows a shared suspension and brake rail; and

FIG. 6 B: shows another embodiment of a layered braking rail.

### DETAILED DESCRIPTION

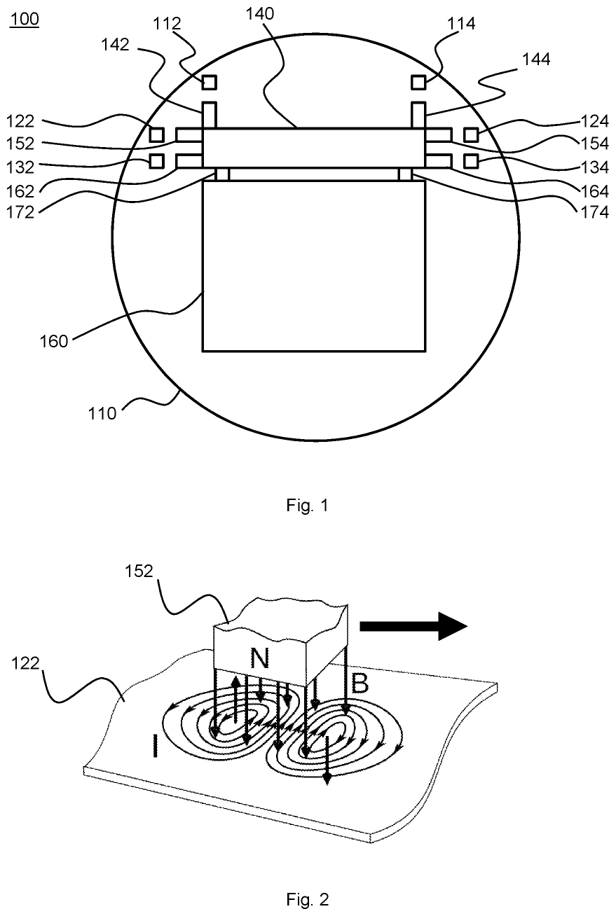

FIG. 1 shows a transportation system 100. The transportation system 100 comprises a tube 110 of which a cross-section is shown, the section being provided in a plane perpendicular to the length of the tube 110. In the tube 110, a first suspension rail 112 and a second suspension rail 114 are provided at the top of the tube 110. At sides of the tube 110, preferably at the upper half an alternatively at the bottom half, a first guide rail 122 and a second guide rail 124 are provided, as well as a first brake rail 132 and a second brake rail 134. The suspension rails and the guide rails provide a track in the transport infrastructure provided by the tube 110 and at least part of the rails.

In the tube 110, a carriage 160 is provided as a vehicle. The carriage 160 may be arranged for carrying people, goods, both, other or a combination thereof. The carriage 160 is connected to a bogie 140 as a basis for suspending the carriage 160. Between the bogie 140 and the carriage, suspension points may be provided, comprising a first air spring 172 and a second air spring 174. Additional air springs may be provided; alternatively or additionally, other types of springs or dampeners may be used. The bogie 140 is preferably elongate—as well as the carriage 160—and at corners and in between front and rear ends of the bogie 140 and the carriage 160, additional air springs may be provided.

The bogie 140 is provided with several magnetically active elements to enable safe, comfortable and efficient control over movement of the carriage 160. At the top of the bogie 140, a first magnetically active suspension element 142 and a second magnetically active suspension element 144 are provided.

The magnetically active suspension elements engage with the suspension rails; the first magnetically active suspension element 142 engages with the first suspension rail 112 and the second magnetically active suspension element 144 engages with the second suspension rail 114. In this sense, engaging means that the magnetically active suspension elements provide a magnetic field that provides a magnetic force that attracts the bogie 140 with the carriage 160 to the suspension rails and provides suspension.

At the sides of the bogie 140, a first magnetically active guide element 152 and a second magnetically active guide element 154 are provided. The magnetically active guide elements engage with the guide rails; the first magnetically active guide element 152 engages with the first guide rail 122 and the second magnetically active guide element 154 engages with the second guide rail 154. In this sense, engaging means that the magnetically active guide elements provide a magnetic field that provides a magnetic force that attracts or dispels the bogie 140 with the carriage 160 to or from the guide rails and provides guidance to the bogie 140 with the carriage 160. More in particular, operation of the magnetically active guide elements allows for controlling the lateral position of the carriage 160 in the tube 110, in a substantially horizontal direction perpendicular to a direction of movement of the carriage 160. Multiple magnetically active guide elements may be provided in line on the bogie 140, at each side of the bogie 140.

At the sides of the bogie 140, a first magnetically active brake element 162 and a second magnetically active brake element 164 are provided. The magnetically active brake elements engage with the brake rails; the first magnetically active brake element 162 engages with the first brake rail 132 and the second magnetically active brake element 164 engages with the second brake rail 134. In this sense, engaging means that the magnetically active brake elements provide a magnetic field that is intended to create Eddy currents in the brake rails. The magnetically active brake elements and the brake rails thus constitute Eddy current brakes. Multiple magnetically active brake elements may be provided in line on the bogie 140, at each side of the bogie 140.

FIG. 2 shows general functionality of an Eddy current brake. A north pole of the first magnetically active brake element 152 is shown, with field lines originating from the north pole and extending to the first brake rail 122. By virtue of movement of the first magnetically active brake element 152 relative to the first brake rail 122, the magnetic field provided by the first magnetically active brake element 152 generated currents in the first brake rail 122: Eddy currents.

The currents thus generated, provide magnetic fields as indicated in FIG. 2. The generated magnetic field causes a drag force acting between the first magnetically active brake element 152 and the first brake rail 122 in opposite direction of the travel direction. As the first magnetically active brake element 152 is connected to the carriage 160 and the first brake rail 122 is connected to the tube 110, operation of the first magnetically active brake element 152 is such that the effect of the field it generated varies relative to the first brake rail, braking of the carriage 160 may be controlled.

As shown by FIG. 1, the magnetically active brake elements are provided adjacent to the brake rails in a horizontal way. To have the magnetically active brake elements engage with the brake rails, the magnetically active brake elements provide magnetic fields of which the field lines debouch from the magnetically active brake elements in a direction that is, in use of the system, substantially horizontal and perpendicular to a direction of movement of the carriage 160. It is noted that embodiments may be envisaged in which the magnetically active brake elements are provided such that field lines debouching from the magnetically active brake elements are not horizontal in use, but under an angle with a horizontal plane. That angle may be small, about five degrees, but also larger, about 30 degrees, 45 degrees or even 60 degrees. The angle may be upward as well as downward.

When the magnetically active brake elements are operated, a magnetic force is excited, interacting between the magnetically active brake elements and thus the carriage on one hand and the brake rails on the other hand.

With the field lines of the field provided by the magnetically active brake elements, any force due to the interaction between the magnetically active brake elements and the brake rails is in this embodiment perpendicular to the suspension force. Hence by virtue of their orthogonal orientation, braking is independent from suspension, which enhances safety.

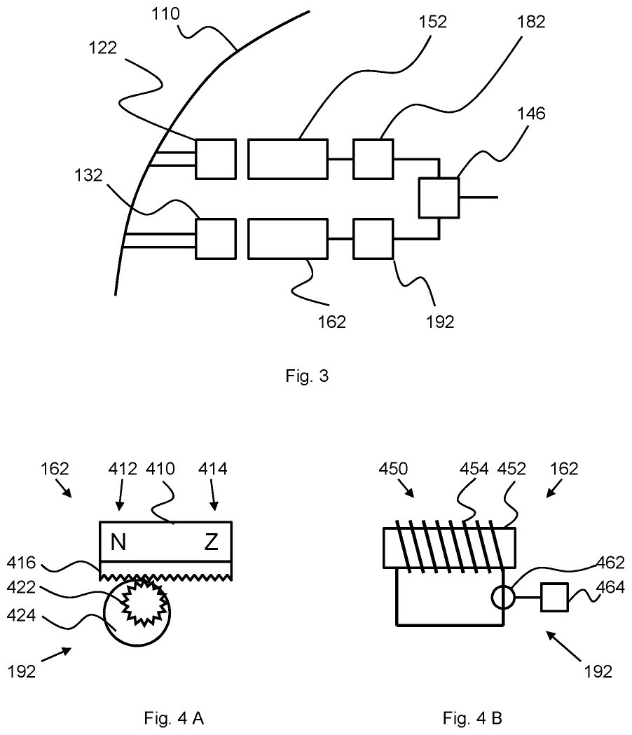

FIG. 3 shows a more detailed view of the upper left of the drawing of FIG. 1. FIG. 3 shows the first guide rail 122 connected to the tube 110 and the first brake rail 132 connected to the tube. The first magnetically active guide element 152 is connected to a first guide magnet actuator 182 and the first magnetically active brake element 162 is connected to a first brake magnet actuator 192. Both the first guide magnet actuator 182 and the first brake magnet actuator 192 are connected to a bogie control unit 146 which is arranged to operate the first guide magnet actuator 182 and the first brake magnet actuator 192.

FIG. 4 A and FIG. 4 B show examples how the magnet actuators may actuate the magnetically active elements. The magnetically active elements are actuated such that at a particular location relative to the bogie 140, a magnetic field is provided having a pre-determined magnitude at the particular location. The particular location is in particular a location at a side of the bogie 140 or the carriage 160, distal or proximal, or in the middle of a rail with which the magnetically active element is intended to engage.

FIG. 4 A and FIG. 4 B show the first magnetically active brake element 162; it is noted that the other magnetically active elements may be implemented similarly. FIG. 4 A shows an example of mechanical actuation. The first magnetically active element 162 comprises in this example a permanent magnet 410 having a north pole 412 and a south pole 414. In one embodiment, the permanent magnet 410 is implemented as comprising an array of magnets and a Halbach array in particular. The permanent magnet 410 is provided with a toothed rack 416 that is arranged to engage with a gear 422 for laterally moving the permanent magnet 410 relative to the first brake rail 132.

The permanent magnet 410 may be translated perpendicularly to the direction of movement; in another embodiment, the permanent magnet 410 is moved towards the first brake rail 132 in another direction, yet having a component perpendicular to the direction of movement of the vehicle 160. In yet another embodiment, the permanent magnet 410 is brought towards the first brake rail 132 via another movement. In this way, the magnetic field strength at the location of the first brake rail 132 is controlled, thus controlling the brake force.

FIG. 4 B shows an example of electrical actuation. The first magnetically active element 162 comprises in this example an electromagnet 450 comprising a core 452 over which a wincing 454 is provided. The electromagnet 450 is via a conductive connection connected to a controllable current source 462 and a current controller 464 as the first brake magnet actuator 192. The current controller 464 is arranged to control a current provided by the controllable current source 462. By controlling the current provided by the controllable current source 462, magnitude of a magnetic field at the location of the first brake rail 162 may be controlled. This allows a brake force of the Eddy current brake thus constituted to be controlled.

The magnetic force provided at a pre-determined distance to the brake rails may depend on various parameters. Hence, control of the movement of the permanent magnet 410 or of the current provided to the electromagnet 450 may be executed based on different control parameters. In one embodiment, a control parameter is the braking force applied. Other control parameters may be acceleration, jerk—or limitation thereof —, vehicle speed, position relative to an obstacle, vehicle geometry like position relative to a bend, other, or a combination thereof. To this end, the bogie 140 may comprise several sensors, including, but not limited to, speed sensors, gyroscopes, accelerometers, other, or a combination thereof, providing input to the bogie controller 146.

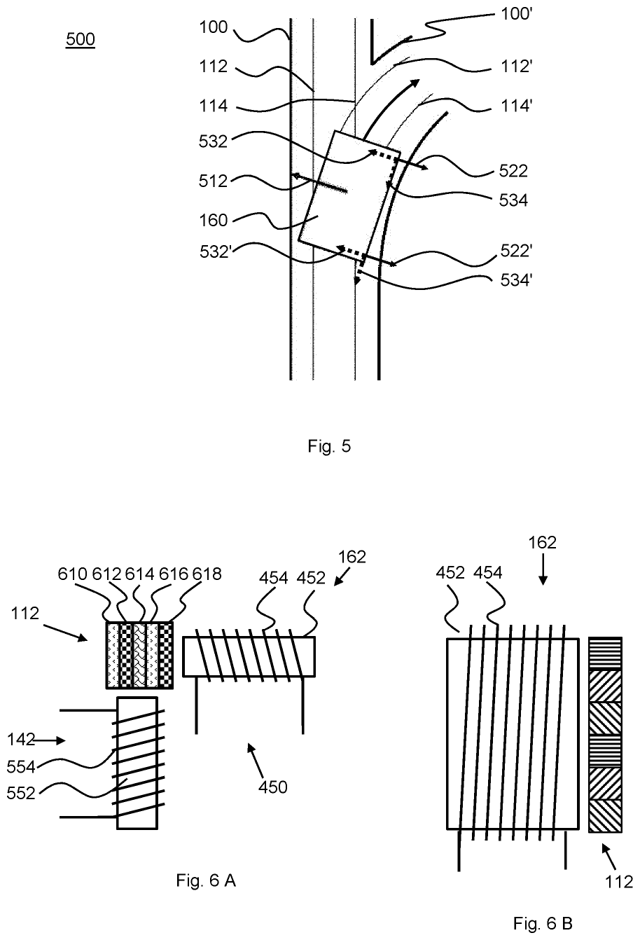

Upon operation of the Eddy current brake, the magnetically active brake elements are pushed away from the brake rails. At linear stretches, with brake rails provided at both sides of the tube 110, forces compensate one another at opposite lateral sides of the bogie 140. However, at switches of a track, brake rails may not be present at both sides of the tube 110. This is depicted in FIG. 5.

FIG. 5 shows a switch 500 in the tube 110. The switch 500 is shown from the top side. The first suspension rail 112 is connected to a branched first suspension rail 112′ and the second suspension rail 114 is connected to a branched second suspension rail 114′. By, for example, deactivating the first magnetically active guide element 152, the carriage 160 is guided to a branched tube 100′, following a curved trajectory. By virtue of the curvature of the trajectory, a centrifugal force 512 works on the carriage 160.

In order to properly follow the curved trajectory, second magnetically active guide element 154 is actuated. In this example, two second magnetically active guide elements are provided, at a leading side of the carriage 160—or actually, the bogie 140—and at a trailing side of the carriage 160 or the bogie 140. Two second magnetically active guide elements are activated such that the centrifugal force is countered, which results in the carriage 160 following the depicted curved trajectory.

FIG. 5 also shows, by means of dotted lines, forces generated by operating the second magnetically active brake element 164. Two second magnetically active brake elements are provided, at a leading side of the carriage 160—or actually, the bogie 140—and at a trailing side of the carriage 160 or the bogie 140. As discussed above, operation of the Eddy current brake by actuating the second magnetically active brake elements results in a first drag force 534 and a second drag force 534′ that effectuate the braking. And actuating the second magnetically active brake elements results, as discussed above, in a first lateral force 532 and second lateral force 532′, which forces push the carriage away from the second guide rail and away from the curved trajectory.

As in the middle of the switch, the first brake rail 122 is not present, at least one of the first lateral force 532 and second lateral force 532′ are not compensated by actuation of magnetically active brake elements at the left side of the vehicle. Hence, in the switch 500, during operation of the horizontal Eddy current brake, the repelling force due to operation of the Eddy current brake needs to be compensated by further actuation of the second magnetically active guide elements.

The bogie control unit 146 (FIG. 3) is arranged to determine, based on at least one of the velocity of the carriage 160, the way the second magnetically active brake elements are powered and the curvature of the trajectory to follow for the carriage 160 to properly enter the branched tube 100′, how the second magnetically active guide elements are to be actuated to have the carriage 160 properly enter the branched tube 100′. Having determined how to actuate the magnetically active guide elements, the bogie control unit 146 operates second guide magnet actuators such that the second magnetically active guide elements are actuated as determined.

Furthermore, the bogie control unit 146 is arranged to control the magnetically active guide elements to compensate for a force acting on the bogie 140 by virtue of operating the magnetically active brake elements in a braking action. Actuating the magnetically active brake elements results in a braking force acting opposite to the direction of movement of the bogie 140 and the carriage 160, but also in a force pushing the magnetically active brake elements away from an adjacent brake rail. Such force may be countered by operating the magnetically active guide elements, for example to maintain distance between the bogie 140 and the guiding tracks or the wall of the tube 110 within a pre-determined range. Furthermore, the magnetically active brake elements may be used to push the bogie 140 with the carriage 160 away from the brake rail.

In the examples above, the transport infrastructure has been presented as comprising three types of rails, for suspension, guiding and braking. This constellation allows for optimising materials and further constructions of the rails for each purpose. The suspension rails are preferably manufactured from a ferromagnetic material to provide a significant magnetic force between the magnetically active suspension elements and the suspensions rails.

It is preferred that a low amount of Eddy currents is generated in the suspension rails that may reduce the effective forces and may lead to drag and loss of energy. This is in particular the case if the suspension rails are also use for propulsion of the vehicle with the bogie 140 and the carriage 160. Ensuring low Eddy currents may be effectuated by providing the suspension rails in a layered structure, in which the layers are provided parallel to the orientation of the suspension field excited by the magnetically active suspension elements. Between the layers, an electrically insulation layer may be provided.

The brake rails are preferably provided such that an exciting magnetic field creates significant Eddy currents, but relatively low magnetic interaction as a result of the Eddy currents. Hence, a layered structure is not preferred—or in any case not a layered structure in which layers are parallel to the orientation of the braking field. However, layers may be oriented perpendicularly relative to the braking field excited by the magnetically active brake elements. Hence, the brake currents are preferably provided in a non-ferromagnetic material like copper or aluminium. In one embodiment, material comprised by the brake rails at a specific location may be chosen dependent on an expected speed at the specific location. High-conductivity material is preferred at higher speeds and low-conductivity material is preferred at lower speeds.

As for the guide rails, a ferromagnetic material is preferred. Furthermore, as Eddy currents are preferably kept low, a layered structure is preferred, with layers provided parallel to the orientation of the guiding field. Since the guiding field is substantially perpendicularly oriented relative to the suspension field, it is rather difficult to use one and the same rails for guiding and suspension—though this is not excluded as an option; efficiency may be obtained by providing layers under an angle with mutually orthogonally oriented field. Such angle is preferably 45°, but may be between 30° and 60° with either field orientation.

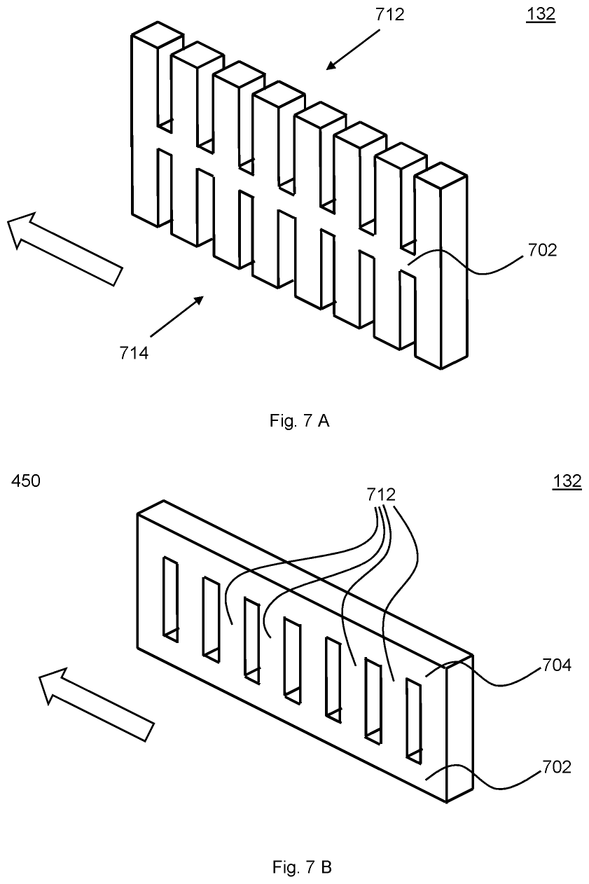

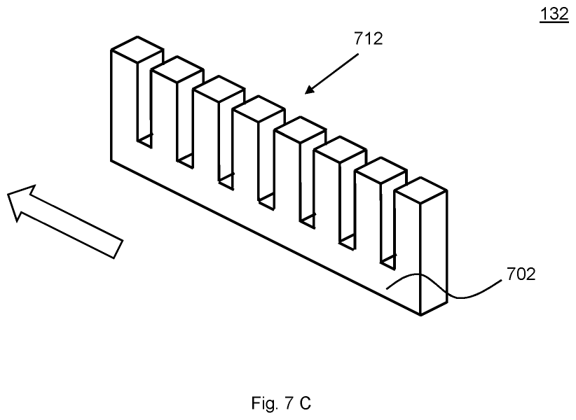

FIG. 6 A shows the suspension rail 112 in further detail as a specific embodiment. The direction of movement is perpendicular to the paper. Whereas use of a single material, either layered or solid is an option for implementation of the above and more general aspects, this embodiment shows the suspension rail 112 comprising layers of different materials. More in particular, the first suspension rail 112 depicted by FIG. 6 A comprises a first layer 610 of a paramagnetic material, like aluminium, another paramagnetic material or a combination thereof. Furthermore, gaps may be provided, in which case one of the layers may be air or void.

The first suspension rail 112 further comprises a second layer 612 of a diamagnetic material like copper, lead, other, or a combination thereof. The first suspension rail 112 further comprises a third layer 614 of a ferromagnetic material like steel, iron, cobalt, nickel, other, or a combination thereof. It is noted that for all layers, particular alloys may be used. A fourth layer 616 comprises again one or more paramagnetic materials and a fifth layer 618 comprises again one or more diamagnetic materials. It is noted that various options may be envisaged in combining layers of ferromagnetic material and layers comprising other materials in any number of layers of any thickness.

FIG. 6 A furthermore shows the first magnetically active brake element 162. Rather than being provided at a location to engage with the first break rail 132, the first magnetically active brake element 162 is positioned to engage with the first suspension rail 112. The first magnetically active brake element 162 comprises the electromagnet 450 comprising a core 452 over which a winding 454. The core of the electromagnet 450 is provided perpendicularly to the orientation of the layers of the first suspension rail 112. Hence, a magnetic field excited by the electromagnet 450 is provided substantially perpendicular to the orientation of the layers. In this way, upon actuation of the winding 454, Eddy currents oriented within the plane of the layers—and perpendicular to the field excited by the electromagnet 450—are generated such that they do not encounter significant resistance—and provide a significant braking effect.

Also indicated in FIG. 6 A is a further electromagnet comprising a further core 552 and a further wincing 554 as part of the first magnetically active suspension element 142. The further core 552 is oriented parallel to the layers of the first suspension rail. In this way, magnitude of Eddy currents generated by a field excited by the further electromagnet are kept low. On the other hand, by virtue of the ferromagnetic material provided in the third layer 614, a suspension force is generated by excitation of the further winding 554. In this way, this embodiment allows the first suspension 112 rail to also provide the functionality of the first brake rail 132. Alternatively, or additionally, the first brake rail 132 and the second brake rail 134 may be embodied as depicted in FIG. 6 A.

Various further options may be envisaged, in which a part of the first suspension rail 112 close to the electromagnet 450 comprises more layers of diamagnetic and/or paramagnetic material. Further away, from the electromagnet 450, the first suspension rail may comprise more layers of ferromagnetic material. In this embodiment, the further electromagnet or the first magnetically active suspension element 142 more in general, is provided below the left side of the first suspension rail 120 as depicted in FIG. 6 A.

Use of different and multiple paramagnetic and/or diamagnetic materials in various layers is a preferred embodiment, as the braking effect by using different materials varies depending on the velocity of the carriage. Hence, providing multiple layers of different paramagnetic and/or diamagnetic materials in shared brake and suspension rails or in dedicated brake rails provide optimal braking over a wide range of the velocity of the carriage 160.

In another embodiment, the braking rail 112 as depicted by FIG. 6 A may be rotated 90° over an axis perpendicular to the viewing plane. In this way, the different materials are all provided at a first plane of the braking rail 112 that is facing the first magnetically active brake element 162. A second plane of the braking rail 112, facing the first magnetically active suspension element 142, may comprise a material that has optimal or at least more preferred characteristics for functionality of the first magnetically active suspension element 142, i.e. providing suspension.

In another embodiment, one rail at each side of the tube 110 is shared for guiding and braking. In such embodiment, braking may be executed by providing magnetically active brake elements under an angle relative to magnetically active guide elements, in combination with a rail as depicted by FIG. 6 A. Such angle would preferably be about ninety degrees, but is not limited to such angle.

FIG. 6 B shows yet another embodiment of a layered braking rail. In the braking rail 112 as depicted by FIG. 6 B, the materials are provided in an intermittent and optionally periodically repeating fashion provided in the braking rail 112, over the length of the braking rail 112. In this embodiment, is may be preferred to provide no electrical insulation between the materials to enable circular Eddy currents through the materials for an enhanced braking effect, but such insulation may be present in case preferred for any reason. Alternatively or additionally, the first brake rail 132 and the second brake rail 134 may be embodied as depicted in FIG. 6 B.

In yet another embodiment, the various materials of the first brake rail 132 or the first suspension rail 112—and the second brake rail 134 and the second suspension rail 114—are stacked in the direction of movement. FIG. 7 A, FIG. 7 B and FIG. 7 C show particular embodiments of stacking of materials of the first brake rail 132; these examples may also be applied to the first suspension rail 112, the second brake rail 134 and the second suspension rail 114. In the embodiments shown by FIG. 7 A, FIG. 7 B and FIG. 7 C, metal strips are separated by air gaps. The metal strips are mounted to at least one elongate support member.

FIG. 7 A shows a first example. In the first example, an elongate support member 702 is provided. From the elongate support member 702, a set of first metal strips 712 extends away from the elongate support member 702. The metal strips extends preferably all in a direction perpendicular to the length of the elongate support member 702 and hence parallel to one another, but may also be provided under an angle relative to the elongate support member 702. The angle may be between 0° and 90°, between 20° and 80°, between 30° and 60° and between 40° an 50°. 45° Is an option. Other angles or ranges of angles between any of the values referenced above may be possible, for example between 30° and 90° or between 10° and 60°. The block arrow indicates a direction of movement of the carriage 160.

At a side of the elongate body opposite to the side from which the first metal strips 712 extend, second metal strips 714 extend in a direction perpendicular to the length of the elongate support member 702 and in a direction opposite to the direction to which the first metal strips extend.

The elongate body 702, the first metal strips 712 and the second metal strips 714 are preferably provided in one and the same material, such that the first brake rail 132 may be manufactured from one piece of material by sawing, milling, grinding, other or a combination thereof to form the air gaps between the first metal strips. In another embodiment, the first strips 712, the second strips 714 and the elongate support member 702 may comprise different materials.

In one embodiment, two, three, four or more different materials are used for the first strips 712 and the second strips 714. In this embodiment, every second, third, fourth or nth strip is made from the same material or from the same compound like an alloy. The various different metals may be chosen from the same set of metals as discussed in conjunction with FIG. 6 A

In another embodiment, that may be combined with any other embodiment of the first brake rail 132, the width of the air gaps is substantially equal to the width of the first metal strips 712 and the second metal strips 714, measured along the length of the elongate support member 702. In yet another embodiment, the width of the air gap is smaller or larger than the width of the first metal strips 712 and the second metal strips 714, measured along the length of the elongate support member 702.

In again another embodiment, the width of the air gaps and/or the width of the first metal strips 712 and the second metal strips 714, measured along the length of the elongate support member 702 may be varied along the length of the elongate support member 702. The variation may be periodically, incrementing, decrementing, random, or any combination thereof.

In FIG. 7 A, the first metal strips 712 are shown as having the same width and being spaced at the same positions and the same interval as the second metal strips 714. In other embodiments, the width, the location and the periodicity of the first metal strips 712 may vary from those of the second metal strips 714. For example, the location of the first metal strips 712 may be skewed half a period from the locations of the second metal strips 714—with both the first metal strips 712 and the second metal strips 714 being spaced at substantially the same period.

FIG. 7 A shows the first metal strips 712 extending from one edge of the elongate support member 702 to another edge of the elongate support member 702, perpendicular to the length of the elongate support body. And FIG. 7 A shows the first metal strips 712 and the second metal strips 714 as having a substantially square cross-section. In another embodiment, the first metal strips and the second metal strips may have another shape: rectangular, cylindrical, triangular, in a shape of another polygon, other, or an combination thereof. Furthermore, the first metal strips may be wider or narrower than the elongate support member 702.

FIG. 7 B shows another first brake rail 132 as a variation of the first brake rail 132 as shown by FIG. 7 A. The block arrow indicates a direction of movement of the carriage 160. The first brake rail 132 of FIG. 7 B comprises a set of first metal strips 712 having air gaps provided therein between. The set of first metal strips 712 is disposed between a first elongate body 702 and a second elongate body 704. Various configurations and compositions of the first elongate body 702, the second elongate body 704 and the set of first metal strips 712 as discussed in conjunction with FIG. 7 A may also be applied to the first brake rail as shown by FIG. 7 B.

FIG. 7 C shows again another first brake rail 132 as a variation of the first brake rail 132 as shown by FIG. 7 A and FIG. 7 B. The block arrow indicates a direction of movement of the carriage 160. The first brake rail 132 of FIG. 7 B comprises a set of first metal strips 712 having air gaps provided therein between. The set of first metal strips 712 is disposed on a first elongate body 702. Various configurations and compositions of the first elongate body 702, the second elongate body 704 and the set of first metal strips 712 as discussed in conjunction with FIG. 7 A may also be applied to the first brake rail as shown by FIG. 7 C.

In the embodiments discussed above, embodiments with one to two sets of strips and one to two sets of air gaps are discussed. It is noted that also embodiments may be envisaged with multiple layers of air gaps provided parallel to one or more elongate support bodies provided substantially parallel to the length of the first brake rail 132. In one particular embodiment, four to ten elongate support bodies are provided parallel to one another and connected by means of studs as metal strips. The resulting first brake rail 132 may have air gaps oriented parallel to the elongate support bodies rather than perpendicular to the elongate support bodies, stacked in a direction perpendicular to the elongate support bodies.

In the description above, it will be understood that when an element such as layer, region or substrate is referred to as being “on” or “onto” another element, the element is either directly on the other element, or intervening elements may also be present. Also, it will be understood that the values given in the description above, are given by way of example and that other values may be possible and/or may be strived for.

Furthermore, the invention may also be embodied with less components than provided in the embodiments described here, wherein one component carries out multiple functions. Just as well may the invention be embodied using more elements than depicted in the Figures, wherein functions carried out by one component in the embodiment provided are distributed over multiple components.

It is to be noted that the figures are only schematic representations of embodiments of the invention that are given by way of non-limiting examples. For the purpose of clarity and a concise description, features are described herein as part of the same or separate embodiments, however, it will be appreciated that the scope of the invention may include embodiments having combinations of all or some of the features described.

The word ‘comprising’ does not exclude the presence of other features or steps than those listed in a claim. Furthermore, the words ‘a’ and ‘an’ shall not be construed as limited to ‘only one’, but instead are used to mean ‘at least one’, and do not exclude a plurality.

A person skilled in the art will readily appreciate that various parameters and values thereof disclosed in the description may be modified and that various embodiments disclosed and/or claimed may be combined without departing from the scope of the invention.

It is stipulated that the reference signs in the claims do not limit the scope of the claims, but are merely inserted to enhance the legibility of the claims.

1. A control arrangement for a magnetically suspended vehicle, comprising:
a first brake module comprising a first magnetically active brake element and a first brake magnet actuator coupled to the first magnetically active brake element to control the first magnetically active brake element to provide a first magnetic brake field of a pre-determined magnitude at a first pre-determined location relative to the brake module; and
a first lateral control module comprising a first magnetically active control element and a first control magnet actuator coupled to the first magnetically active control element to control the first magnetically active control element to provide a first magnetic control field of a pre-determined magnitude at a first pre-determined location relative to the control module;
wherein the first magnetic brake field and the first magnetic control field are, in use, at the location of the magnetically active elements, substantially perpendicular to an intended direction of travel of the vehicle.

2. The control arrangement according to claim 1, wherein the first brake module is arranged to interact with a first brake track for providing a braking force and the first lateral control module is arranged to interact with a first control track for controlling a control distance between the first lateral control module and the first control track, the control distance being preferably within a pre-determined range.

3. The control arrangement according to claim 1, wherein:
the first magnetically active brake element comprises a first permanent magnet and the brake magnet actuator is arranged to control movement of first permanent magnet in a direction substantially perpendicular to an intended direction of travel of the vehicle; and
the first magnetically active control element comprises an electromagnet and the control magnet actuator is arranged to control a current provided to the electromagnet.

4. The control arrangement according to claim 1, wherein:
the first magnetically active brake element comprises a first electromagnet and the brake magnet actuator is arranged to control a current provided to the electromagnet; and
the first magnetically active control element comprises an electromagnet and the control magnet actuator is arranged to control a current provided to the electromagnet.

5. The control arrangement according to claim 2, further comprising a control processor arranged to control the first magnetically active brake module to have an interaction between the first magnetically active brake element and the first brake track provide a pre-determined braking force on the control arrangement relative to the first brake track.

6. The control arrangement according to claim 2, further comprising a control processor arranged to control the first magnetically active control module, based on the control of the first magnetically active brake module, to maintain the control distance within the pre-determined range.

7. The control arrangement according to claim 1, further comprising:
a second brake module comprising a second magnetically active brake element and a second brake magnet actuator coupled to the second magnetically active brake element to control the second magnetically active brake element to provide a second magnetic brake field of a pre-determined magnitude at a second pre-determined location relative to the brake module; and
a second lateral control module comprising a second magnetically active control element and a second control magnet actuator coupled to the second magnetically active control element to control the second magnetically active control element to provide a second magnetic control field of a pre-determined magnitude at a second pre-determined location relative to the control module;
wherein:
the second magnetic brake field and the second magnetic control field are, in use, at the location of the magnetically active elements, substantially perpendicular to a direction of travel of the vehicle; and
the second lateral control module is provided opposite to the first lateral control module such that second poles of second magnetically active elements from which the second fields debouch face away from first poles of first magnetically active elements from which the first field debouch.

8. The control arrangement according to claim 7, wherein the first magnetically active brake element comprises a first electromagnetic and the brake magnet actuator is arranged to control a current provided to the electromagnetic and
wherein the control processor is arranged to:
receive switch information on a switch in a guiding track along which the vehicle is traveling, the guiding track comprising the first brake track and the first control track at a first side of the guiding track and a second brake track and a second control track at a second side of the guiding track;
operate control module at a side corresponding to the direction information for controlling the control distance within the pre-determined range; and
receive direction information on a direction to take upon approaching the switch;
wherein the control processor is further arranged to, upon receiving a braking signal,
operate the brake module in accordance with the braking signal; and
adjust operation of the control module at the side corresponding to the direction information for controlling the control distance within the pre-determined range.

9. The control arrangement according to claim 8, wherein the control processor is further arranged to, upon arrival at the switch, deactivate the control module at the side not corresponding to the direction information.

10. A vehicle arranged to be magnetically suspendable relative to at least one suspension rail comprised by a transportation infrastructure, the vehicle comprising a control arrangement according to claim 1.

11. A transportation infrastructure arranged for transportation of a vehicle according to claim 10, the transportation infrastructure providing a guiding track arranged to provide guidance to the vehicle, the infrastructure comprising:
the suspension rail;
a braking track comprising a braking rail provided along the guiding track, the braking rail being arranged to engage with the brake module;
a control track comprising a control rail provided along the guiding track, the control rail being arranged to engage with the control module.

12. The transportation infrastructure according to claim 11, wherein the braking track comprises a brake rail comprising metal and the control track comprises a control rail comprising metal.

13. The transportation infrastructure according to claim 12, wherein at least one of the brake rail and the control rail comprise air gaps.

14. The transportation infrastructure according to claim 13, wherein the air gaps are distributed over the length of the at least one of the brake rail and the control rail.

15. The transportation infrastructure according to claim 13, wherein the air gaps are open at three adjacent outer surfaces of the at least one of the brake rail and the control rail.

16. The transportation infrastructure according to claim 12, wherein the at least one of the brake rail and the control rail comprises a first metal elongate support member and metal strips extending from a first the elongate support member at a first side of the metal strips in a direction perpendicular to the length of the elongate support member.

17. The transportation infrastructure according to claim 16, further comprising a second metal elongate support member provided parallel to the first metal elongate support member and connected to the metal strips at a second side opposite to the first side.

18. The transportation infrastructure according to claim 16, further comprising second metals strips extending from the first elongate support member at a second side of the first elongate support member opposite to the first side of the first elongate support member and extending substantially perpendicular relative to the length of the first elongate support member.

19. The transportation infrastructure according to claim 13, wherein the air gaps have an elongate shape.

20. The transportation infrastructure according to claim 19, wherein the air gaps are oriented substantially horizontal relative to the elongate support member.

21. The transportation infrastructure according to claim 19, wherein the air gaps are oriented substantially vertical relative to the elongate support member.

22. The transportation infrastructure according to claim 21, wherein multiple adjacent air gaps are provided in a direction substantially perpendicular to the length of the at least one of the brake rail and the control rail.

23. The transportation infrastructure according to claim 19, wherein the air gaps are oriented under an angle relative to the elongate support member.

24. The transportation infrastructure according to claim 12, wherein at least one of the brake rail and the control rail comprises a solid elongate element.

25. The transportation infrastructure according to claim 12, wherein at least one of the brake rail and the control rail comprises multiple components arranged in a layered structure, wherein the layers are oriented horizontally.

26. The transportation infrastructure according to claim 12, wherein the brake rail comprises multiple vertically oriented components.

27. The transportation infrastructure according to claim 26, wherein the components are arranged in a layered structure parallel to the intended direction of movement of the vehicle.

28. (canceled)

29. The transportation infrastructure according to claim 25, wherein at least two components comprise materials having different magnetic and/or electrical and/or conductive properties.

30. (canceled)
